(19) United States
(12) Patent Application Publication
(10) Pub. No.: US 2012/0260419 A1
(43) Pub. Date: Oct. 18, 2012

(54) Patient transfer apparatus and method

(76) Inventors: Matthew James Mangiacopra, Southington, CT (US); Michael Paul Galecki, Cheshire, CT (US)

(21) Appl. No.: 13/066,384

(22) Filed: Apr. 13, 2011

(51) Int. Cl. A61G 7/10

(52) U.S. Cl. 5/81.1 R

(57) ABSTRACT

A portable sit-to-stand device which provides a platform for receiving a patient's foot, at least one supporting mast and a leg abutment for receiving a patient's leg. The said device provides safety and stability during sit-to-stand and stand-to-sit transfers.

### RELATED APPLICATIONS

The present application is related to U.S. Pat. No. 2,757,388, issued August, 1956, included by reference herein.

The present application is related to U.S. Pat. No. 2,963,713, issued December, 1960, included by reference herein.

The present application is related to U.S. Pat. No. 3,967,329, issued July, 1976, included by reference herein.

The present application is related to U.S. Pat. No. 4,279,043, issued July, 1981, included by reference herein.

The present application is related to U.S. Pat. No. 4,305,579, issued December, 1981, included by reference herein.

The present application is related to U.S. Pat. No. 4,829,612, issued May 16, 1989, included by reference herein.

The present application is related to U.S. Pat. No. 4,844,107, issued Jul. 4, 1989, included by reference herein.

The present application is related to U.S. Pat. No. 5,983,911, issued Nov. 1, 1999, included by reference herein.

The present application is related to U.S. Pat. No. 7,356,858, issued Apr. 15, 2008, included by reference herein.

### FIELD OF THE INVENTION

The present invention relates to a device for healthcare workers for patient transfers and, more particularly to a supporting apparatus that assists patients from sitting to standing, and standing to sitting.

### BACKGROUND OF THE INVENTION

Therapists perform sit-to-stand transfers for patients that need assistance in transfers. These transfers can be used in combination with therapeutic exercise, neuromuscular re-education of movement, and other therapeutic activities. Patient diagnoses include knee replacement, leg amputation, quadriceps muscle rupture, muscle weakness, cerebrovascular accident, traumatic brain injury, etc. In order to perform a sit-to-stand transfer, the therapist must properly support the patient's body as well as provide lifting assistance. The transfer is complicated by factors such as height and weight differences between the patient and the therapist. Generally, if a patient is taller and/or heavier than the therapist, the therapist must exert a substantial effort during the assistance for the patient transfer. This substantial effort can compromise the safety of the patient and therapist.

In a 1999 study published in the Journal of the American Physical Therapy Association conducted by Holder, N. L.; Clark, H. A.; DiBlasio, J. M.; Hughes, C. L.; Scherpf, J. W.; Harding, L.; & Shepard, K. F. the researchers investigated the cause and prevalence of musculoskeletal injuries among 667 physical therapists and physical therapist assistants. The results showed that the most common injuries were to the low back (62% of injured physical therapists) followed by injuries to the upper back and wrist (25%). It was found that the most prevalent causes of work-related musculoskeletal disorders (WMSDs) were transferring a patient (30%) and lifting a patient (25%). In addition, the WMSDs are exacerbated by continuing clinical practice, with transferring a patient and lifting being cited in the top four activities that cause a reoccurrence of symptoms (30% and 35% respectively).

A second study published in the Journal of the American Physical Therapy Association conducted by Campo, M.; Weiser, S.; Koenig, K. L.; and Nordin, M. in 2008 is consistent with the results of the previous study. Exactly 882 physical therapists participated in this study. About 57% of respondents reported complaints of WMSDs. The study focused on the two most common injuries: injuries to the lower back and to the wrist/hand. Once again, the primary cause of these injuries was patient transferring. The results indicate that when therapists transferred patients 6 to 10 times a day, their odds of developing low back WMSDs were 2.4 times higher than when no transfers were performed.

Currently, the only way to address this problem is for the therapist (or multiple therapists) to use a blocking technique in which the therapist uses his/her body to provide support for the patient. However, it is unsafe for the following reasons: it risks injury to the therapist by placing strain on lower back and knees, and it doesn't provide ideal stability for the patient. Additionally, this is not a comprehensive solution because it often calls for multiple therapists, which increases healthcare cost and is not time efficient.

Therapists rely on proper body mechanics to avoid injury. Proper body mechanics alone cannot protect therapists from injury. According to a 1999 study published in Ergonomics conducted by Marras, W. S.; Davis, K. G.; Kirking, B. C.; & Bertsche, P. K. biomechanical evidence confirms this finding and has demonstrated that there is no safe way to lift a dependent patient. Even a transfer task with a light patient who is compliant, results in spinal loading that exceeds tissue thresholds of the therapist.

In 2009, a study published in The American Journal of Occupational Therapy, conducted by Darragh, A. R.; Huddleston, W.; & King, P., focused on occupational and physical therapists in order to describe the prevalence of WMSDs and the effect they had on work practices. In the study, 1189 therapists responded to the high rate of WMSDs in three ways: changing body mechanics (50%), increasing use of other personnel (43%), and changing work positions more frequently (24%). The study shows that the therapists tend to work through their injuries, so as not to decrease patient contact time; nevertheless, this tendency to alter work habits is a temporary solution that leads to a reoccurrence of symptoms.

To reduce the risk of sustaining WMSDs, research results recommend that therapists take protective measures such as instituting lifting policies, using lifting teams, and using equipment such as mechanical lift devices.

U.S. Pat. No. 4,829,612 discloses in FIG. 2 and column 3 line 25 a patient transfer apparatus that includes a rotatable table, mast, and a leg abutment member. The rotatable table provides an unnecessary degree of freedom during a sit-to-stand transfer and is more suitable for moving a patient from location to location. Also when using said apparatus, the therapist must provide a counterweight force in order to support the patient's weight. This balancing act compromises patient and therapist safety. This apparatus supports both legs during sit-to-stand transfer, however it cannot be used for supporting only one leg. Furthermore it cannot be easily removed from underneath the patient's foot once the patient is in a stand position.

U.S. Pat. No. 4,844,107 discloses in column 3 line 1 a portable standing and seating aid that that can be used for patient sit-to-stand transfers. The device provides support for the patient to grasp and assist themselves from sitting to standing or standing to sitting using arms and shoulders. This device provides no means of supporting the patient's legs to preserve proper body mechanics. During a sit-to-stand transfer, the patient's legs could buckle allowing the patient to fall into the device.

A device commercially available as item # 562533 from Patterson Medical, in Bolingbrook, Ill., is the E-Z Turn II Transfer Disk (“EZ product”). The EZ product functions similarly to the device described in U.S. Pat. No. 4,829,612 because the EZ product supports both legs during a sit-to-stand transfer. The EZ product is similar to the device in U.S. Pat. No. 4,844,107 because the patient must use the support arm to pull themselves into a standing position using arms and shoulders. The EZ product provides support for both legs during sit-to-stand transfer; however it cannot be used to support only one leg. The EZ product has one platform that both of the patient's feet stand on. Therefore, the EZ product cannot be easily removed from underneath the patient's feet once the patient is in a stand position.

### SUMMARY OF THE INVENTION

In accordance with the present invention, there is provided a sit-to-stand supporting apparatus having a platform and a leg abutment member. The platform is flat and receives the foot of a patient. The leg abutment member extends upwardly perpendicular from the platform and receives the leg of a patient. An optional handle can be incorporated to assist in transport, positioning and removal during patient use. An optional strap can be incorporated to assist in retaining and holding the patient during use. An optional height adjustment mechanism can be incorporated to assist in positioning for use. An optional folding mechanism can be incorporated to assist in transport and storage.

It is therefore an object of the invention to provide the patient with lateral (side to side) and ventral (front to back) leg support to allow the patient to transfer from a sitting to standing position or standing to sitting position.

It is another object of the invention to provide a portable apparatus that the healthcare worker can easily position for the patient and remove when no longer in use.

It is another object of the invention to provide support for the patient such that the healthcare worker is not required to support the patient's leg.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of the patient transfer apparatus;

FIG. 2 is a right side view of the patient transfer apparatus;

FIG. 3 is a top view of the patient transfer apparatus;

FIG. 4 is a right side view of the patient transfer apparatus in use where the patient is in a seated position; and

FIG. 5 is a right view of the patient transfer apparatus in use where the patient is in a standing position.

For purposes of clarity and brevity, like elements and components will bear the same designations and numbering throughout the Figures.

### DESCRIPTION OF THE PREFERRED EMBODIMENT

The patient transfer apparatus comprises a platform, a platform traction surface, a foot traction surface positioned upon the platform, at least one mast attached to the platform, and a leg abutment in communication with at least one mast. The platform traction surface may be removably attached to the bottom face of the platform. The foot traction surface may be removably attached to the top face of the platform. The leg abutment may further comprise a removably attached leg abutment pad. The patient transfer apparatus may comprise at least one handle, at least one folding mechanism, at least one height adjustment mechanism, and at least one strap.

The patient transfer apparatus comprises a platform, a means for receiving and retaining a patient's foot in communication with the platform, a means for supporting a patient's leg in communication with the platform, and a means for providing traction for the platform. The patient transfer apparatus may comprise a means for receiving and retaining the patient's feet and legs in communication with the platform.

The method of enabling healthcare workers to aid a patient in sit-to-stand and stand-to-sit transfers comprises the steps of: providing a patient transfer apparatus, placing a foot of a patient onto a platform of the patient transfer apparatus, moving the patient transfer apparatus toward the patient until a knee of said patient contacts or comes in close proximity to a leg abutment of the patient transfer apparatus, initiating a patient sit-to-stand transfer, and moving the patient to a standing position. The method may further comprise removing the patient transfer apparatus from under the standing patient thereby allowing freedom of movement. Alternatively, the method may further comprise the steps of: initiating a patient stand-to-sit transfer, moving the patient to a sitting position, and removing the patient transfer apparatus from under the sitting patient thereby allowing freedom of movement. Furthermore, the method may further comprise the steps of: adjusting the height of the patient transfer apparatus, folding and unfolding the patient transfer apparatus, and strapping and unstrapping the patient to the patient transfer apparatus.

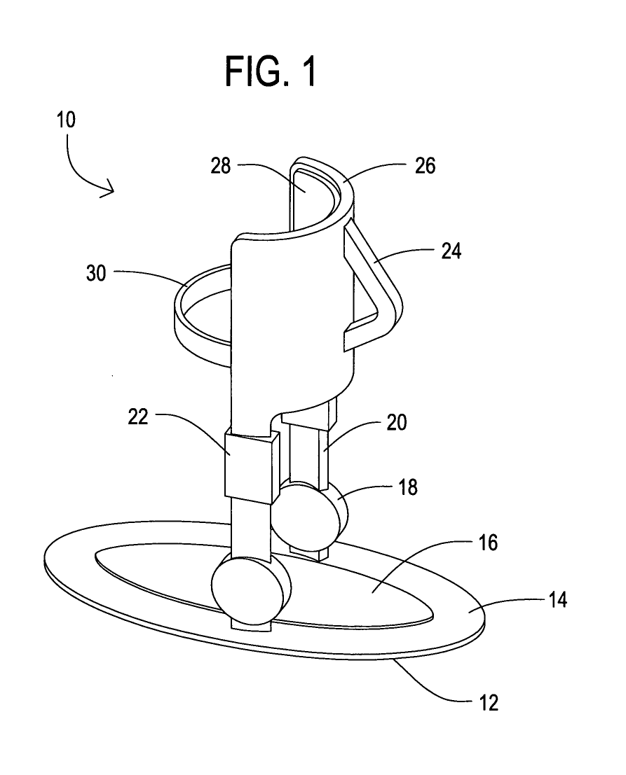

As can be seen in FIG. 1, the patient transfer apparatus 10 includes a platform traction surface 12, on the bottom face of the patient transfer apparatus 10 to engage the floor. The patient transfer apparatus 10 also includes a platform 14, a foot traction surface 16, at least one mast 20, a leg abutment 26, and a leg abutment pad 28. As can also be seen in FIG. 1, the patient transfer apparatus 10 may include a handle 24. Each of these elements combines to form a preferred embodiment of the patient transfer apparatus 10.

Referring to FIG. 1, there is shown the platform 14 forming the base for the patient transfer apparatus 10. The platform 14 may be made of plastic, wood, metal or any other suitable material. Preferably, the platform 14 has a flat lower surface that receives the platform traction surface 12. The platform traction surface 12 maybe made of a rubber non-slip material to increase traction between the floor and the platform 14. Preferably, the platform 14 has a flat upper surface that receives the foot traction surface 16. The foot traction surface 16 may be made of a rubber non-slip material, an adhesive backed traction pad, or any other suitable material. Alternatively, the foot traction surface 16 may be integrated into rough texturing on the upper surface of the platform 14. The platform 14 provides a base to support the mast 20.

The mast 20 may be comprised of one or multiple members that extend upwardly from the platform 14. The mast 20 may be bolted, threaded, welded, or otherwise attached to the platform 14. The mast 20 maybe made of plastic, wood, metal or any other suitable material.

The leg abutment 26 may be bolted, threaded, welded, or otherwise attached to the mast 20. The leg abutment 26 may have a flat or curved surface for receiving the patient's leg. The leg abutment 26 maybe made of plastic, wood, metal or any other suitable material. Alternatively the platform 14, mast 20, and leg abutment 26 may be formed in one piece or a combination thereof. In addition, mast 20 may comprise at least one folding mechanism 18 such as a hinge, detent pin mechanism or any other suitable mechanism. This folding mechanism 18 will provide collapsibility of the patient transfer apparatus 10 for storage, portability, or any other desired reason. In addition, the patient transfer apparatus 10 may comprise at least one height adjustment mechanism 22 such as a detent pin mechanism, telescopic tubing, or any other suitable mechanism. This height adjustment mechanism 22 will assist in positioning the leg abutment 26 for various patient heights. In addition, the patient transfer apparatus 10 may comprise at least one strap 30. The strap 30 may be made of nylon, rubber, or any other suitable material. The strap 30 will assist in retaining and holding the patient to the patient transfer apparatus 10. A strap 30 may be bolted, threaded, welded, or otherwise attached to the leg abutment 26, mast 20 and platform 14. In a preferred embodiment as shown in FIG. 1, the strap 30 is attached to the leg abutment 26. Alternatively a plurality of straps may be attached to the patient transfer apparatus.

The leg abutment pad 28 removably attaches to the leg abutment 26. The leg abutment pad 28 may be made of foam, rubber, or any other suitable material to provide cushion between the patient's leg and leg abutment 26.

Referring to FIG. 1, the handle 24 may be made of plastic, wood, metal, or any other suitable material. A handle 24 may be bolted, threaded, welded, or otherwise attached to the leg abutment 26, mast 20 and platform 14. In a preferred embodiment as shown in FIG. 1, the handle 24 is attached to the leg abutment 26. Alternatively, a plurality of handles may be attached to the patient transfer apparatus 10.

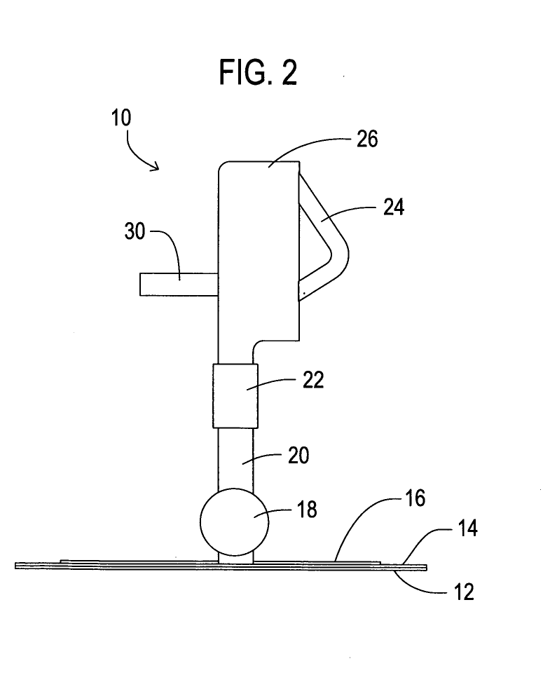

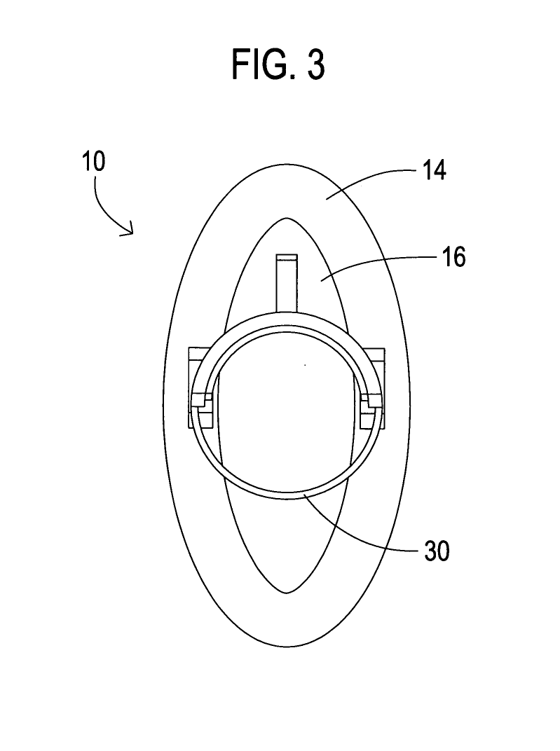

FIG. 2 and FIG. 3 are alternate views of the patient transfer apparatus 10.

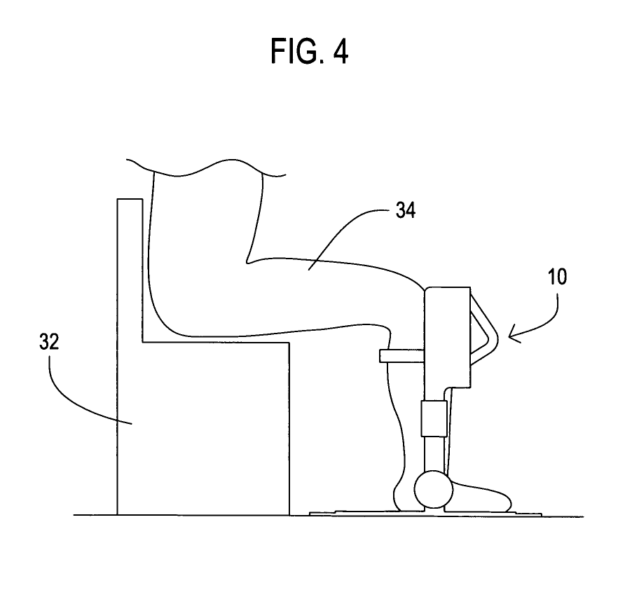

FIG. 4 shows the initial stage of the operation of the present invention. It can be seen in FIG. 4, the patient 34 is seated on a seat device 32 such as a chair, wheel chair or any other suitable device. The patient 34 initially has a foot placed on the foot traction surface 16 on the upper surface of the platform 14. The therapist positions the patient transfer apparatus 10 against the patient's knee. Patient 34 initiates a sit-to-stand transfer that may or may not require assistance by the therapist. During the sit-to-stand transfer, the patient's knee is laterally (side to side) and ventrally (front to back) supported by the leg abutment 26. The configuration of the patient transfer apparatus 10 allows for proper body mechanics of the patient 34 during the sit-to-stand transfer. The leg abutment 26 provides a pivot point for the patient's knee that increases stability of the patient 34.

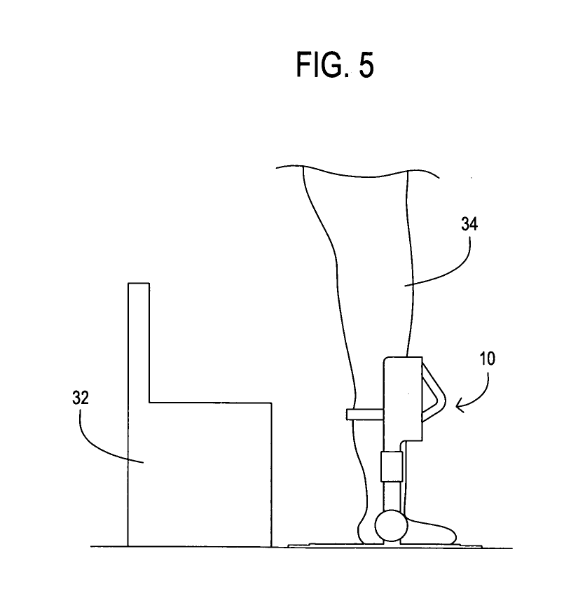

FIG. 5 shows the patient 34 standing after the sit-to-stand transfer. From this standing position the patient 34 can perform a stand-to-sit transfer or the patient transfer apparatus 10 may be removed to allow patient 34 to move freely. During the stand-to-sit transfer, proper body mechanics are preserved by supporting the patient's knee against the leg abutment 26.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A patient transfer apparatus comprising:
a) a platform;
b) a platform traction surface;
c) a foot traction surface positioned upon the platform;
d) at least one mast attached to the platform; and
e) a leg abutment in communication with at least one mast.

2. The patient transfer apparatus of claim 1 wherein the platform traction surface removably attaches to the bottom face of the platform.

3. The patient transfer apparatus of claim 1 wherein the foot traction surface removably attaches to the top face of the platform.

4. The patient transfer apparatus of claim 1 wherein the leg abutment further comprises a removably attached leg abutment pad.

5. The patient transfer apparatus of claim 1 further comprising at least one handle attached to the patient transfer apparatus.

6. The patient transfer apparatus of claim 1 further comprising at least one folding mechanism.

7. The patient transfer apparatus of claim 1 further comprising at least one height adjustment mechanism.

8. The patient transfer apparatus of claim 1 further comprising at least one strap.

9. A patient transfer apparatus comprising;
a) a platform;
b) a means for receiving and retaining a patient's foot in communication with the platform;
c) a means for supporting a patient's leg in communication with the platform; and
d) a means for providing traction for the platform.

10. The patient transfer apparatus of claim 9 where in the b) means further comprises means for receiving and retaining the patient's feet in communication with the platform.

11. The patient transfer apparatus of claim 9 where in the c) means further comprises means for supporting the patient's legs in communication with the platform.

12. A method of enabling healthcare workers to aid a patient in sit-to-stand and stand-to-sit transfers comprising the steps of;
a) providing a patient transfer apparatus
b) placing a foot of a patient onto a platform of the patient transfer apparatus;
c) moving the patient transfer apparatus toward the patient until a knee of said patient contacts or comes in close proximity to a leg abutment of the patient transfer apparatus;
d) initiating a patient sit-to-stand transfer; and
e) moving the patient to a standing position.

13. The method of claim 12 further comprising the step of removing the patient transfer apparatus from under the standing patient thereby allowing freedom of movement.

14. The method of claim 12 wherein the step d) and e) comprises;
d) initiating a patient stand-to-sit transfer; and
e) moving the patient to a sitting position.

15. The method of claim 12 further comprising the step of b1) adjusting the height of the patient transfer apparatus.

16. The method of claim 12 further comprising the steps;
a1) unfolding and the patient transfer apparatus;
e1) folding the patient transfer apparatus;

17. The method of claim 12 further comprising the step c1) strapping the patient to the patient transfer apparatus.

18. The method of claim 14 further comprising the step of removing the patient transfer apparatus from under the patient thereby allowing freedom of movement.
